(19) United States
(12) Patent Application Publication
(10) Pub. No.: US 2011/0083870 A1
(43) Pub. Date: Apr. 14, 2011

(54) Combination of Impact Tool And Shaped Relatively Lower Modulus Material

(76) Inventors: H. Downman McCarty II, Whitehall, MD (US); Peter Popper, Wilmington, DE (US); James L. Glancey, Blackbird, DE (US); Brooke Schumm Ill, Ellicott City, MD (US)

(21) Appl. No.: 12/083,903

(22) PCT Filed: Sep. 25, 2006
(86) PCT No.: PCT/US2006/037163

§ 371 Date: Dec. 20, 2010

Related U.S. Application Data
(60) Provisional application No. 60/596,451, filed on Sep. 23, 2005.
(60) Provisional application No. 60/597,367, filed on Nov. 28, 2005.

(51) Int. Cl. B25D 17/11; B25D 17/24

(52) U.S. Cl. 173/211; 173/162.1

(57) ABSTRACT

An impacting tool, such as a jackhammer or electric hammer is proposed to be modified by a high modulus polymeric material, or metal of lower relative modulus than surrounding metal such as that of a piston. An interchangeable tool head is proposed to have inserted in a cavity in the impacted end such a high modulus polymeric material. Thus the term relatively lower modulus inclusion (“RLMI”) has been selected for the descriptive term. By using such relatively lower modulus material for an inclusion, which inclusion can be an insert, and modification of the piston or ram or impacting end of the tool, and additionally, if desired, the stop end of the piston or ram, the invention enables reduction of noise and vibration without substantially diminishing impact effectiveness and working time. Additionally, the working end of a cutting or impacting tool can be modified to a sharper angle because of diminished force through such relatively lower modulus inclusion. The edge angle, of for instance a chisel, may be modified to take advantage of mechanical changes resulting from the relatively lower modulus inclusion.

### CONTINUATION DATA

For any application into national or regional stage for which this application can be continued (or its substantive equivalent) from an earlier application, and for PCT purposes, a continuation-in-part of U.S. Provisional Application 60/596,451 filed 23 Sep. 2005 bearing the name “Combination of Modified Impact Tool and Shaped Relatively Lower Modulus Material” and U.S. Provisional Application 60/597,367 filed on 28 Nov. 2005 entitled “Impact Tool With Relatively Lower Modulus Insert for Reducing Vibration and Noise.” Not for PCT purposes, but for purposes of the United States, in addition, to the extent permitted under continuation and continuation-in-part practice prior to issuance, the resulting utility application from this provisional application is a continuation in part of PCT/US02/23448 entitled “An Anti-Spalling Combination on an Impact Tool With an Improved Holding System” and entry into the U.S. national stage of PCT/US02/23448 filed in the United States as Receiving Office pending as Ser. No. 10/625,149, which PCT Application PCT/US02/23448 in turn is a continuation in part of provisional applications filed on Jul. 23, 2001 Nos. 60/307,198, and 60/356,804 filed on February 13, 2002, both filed in the United States, and a U.S. Provisional Application 60/826,848 filed on 25 Sep. 2006. Such applications are adopted by reference.

### FIELD OF INVENTION

The field of invention relates to impact tools, especially power impact tools, and more especially oscillating impact tools typically powered pneumatically or electrically, and insertion or inclusion of a particular material as a relatively lower modulus inclusion (RLMI), to accomplish a reduction of noise and vibration from such tools. Further, improvement of interchangeable tool bits used in impact tools is proposed by an RLMI.

### SUMMARY OF INVENTION

The inventors propose to modify impact tools with a contained piston or ram. An important element of the modification is the use of a high modulus inclusion of polymeric material or use of a lower modulus metal material than an adjacent metal material. Such material in all events is to be softer than the adjacent impacting metal parts, i.e., such material is to be of a relatively lower modulus. A polymeric material selected will be a high modulus material; however, it is a relatively lower modulus than the adjacent impacted metal. A metal material selected for the inclusion will be of lower modulus than the adjacent metal, and is thus a relatively lower modulus, but such metal material will be likely have a relatively high modulus compared to most polymeric materials. Thus the term relatively lower modulus inclusion (“RLMI”) has been selected for the descriptive term. By using such relatively lower modulus material for an inclusion, which inclusion can be an insert, and modification of the piston or ram or impacting end of the tool, and additionally, if desired, the stop end of the piston or ram, the invention enables reduction of noise and vibration without substantially diminishing impact effectiveness and working time. Additionally, the working end of a cutting or impacting tool can be modified to a sharper angle because of diminished force through such relatively lower modulus inclusion. The tool edge angle, of for instance a chisel, is proposed to be modified to take advantage of mechanical changes resulting from the relatively lower modulus inclusion.

### BACKGROUND

The power tool and hand tool industry, and the industry more broadly described as impacting tools, have been plagued by problems of metal to metal noise, and attendant vibration. Further, metal tools have issues of spalling, mushrooming and chipping. The most compelling needs for noise reduction in impacting tools is in oscillating impacting tools such as jackhammers and airhammers. The invention by McCarty et al, filed as PCT/US02/23448 and published by the World International Patent Organization, describes a shaped polymeric material, including a disk, to address these problems. The materials described therein and the overall specification is adopted herein by reference. Unfortunately, a mere disk is not particularly useful in oscillating and/or reciprocating piston (oscillating being defined to include reciprocating) impact tools at the point where a ram or piston contacts a working tool or object being driven because it degrades too quickly. The present invention is designed to accomplish the goals of noise attenuation and biomechanical advantage, as well as safety, in a novel way by modification of the piston or ram in the impacting tool, or impacted tool in conjunction with a relatively lower modulus inclusion.

### OBJECTS OF THE INVENTION

An object is to reduce the noise and thereby reduce aural hardship on a user of the impact tool.

Another object is to accomplish the above objects without significantly reducing the cutting effectiveness or impacting effectiveness of the tool compared to the same tool without the invention applied to the tool.

Another object is to reduce biomechanical and neurological damage to the arm through attenuation of impact shock.

Another object is to increase the longevity of the impacted tool.

Another object of the invention is to prevent injury by limiting spalling, mushrooming, and chipping.

### DESCRIPTION OF FIGURES

FIG. 1 shows a power impacter, and the relative positions of the preferred mode of the invention, including the RLMI, an interchangeable working tool, and a rear disk that contacts the piston stops made of a high modulus polymeric material.

FIG. 2 has four sub-figures. FIG. 2a shows an unmodified piston or ram, and the end of an interchangeable tool. FIG. 2b shows an RLMI in a cavity in a piston adjacent to an interchangeable tool. FIG. 2c shows FIG. 2a with a rear disk of polymeric material added. FIG. 2d shows a preferred mode with an RLMI in a cavity in a piston adjacent to an interchangeable tool and a rear disk of polymeric material added.

FIG. 3 shows a non-modified piston with an RLMI in a cavity located at the impact end of an interchangeable working tool.

FIG. 4 shows an alternate mode of a disk encased in a supporting metal ring with protrusions of the disk of a shaped polymeric material to prevent metal to metal contact, which disc is interposed between a ram or piston and a tool.

FIG. 5 shows an exploded sectional view of a preferred mode with the RLMI in the piston and a rear disc similar to FIG. 2d.

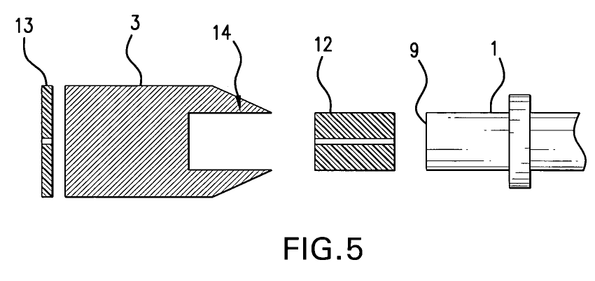

FIG. 6 shows an exploded view of a steel tool being impacted that has an RLMI inserted in it and shows the relative position of the RLMI, the RLMI cavity and the steel tool being impacted (the impacted tool).

FIG. 7 shows a close up view of the RLMI protrusion from a steel tool.

### DESCRIPTION AND PREFERRED MODE OF INVENTION

The function of a power impact tool is to cut or chip a relatively hard material. Examples of items being cut are: metal rods, and in certain circumstances, metal plates or sheets, metal bolts impossible to remove by other means, concrete that needs to be removed, and, stone to be carved. Power impact tools also comprehend a variety of electrically or pneumatically driven tools that involve metal to metal contact including impact wrenches, impact drills, hammer drills, pile drivers, nail guns, certain driven ratchet wrenches and hand nailers sometimes called “palm nailers.”

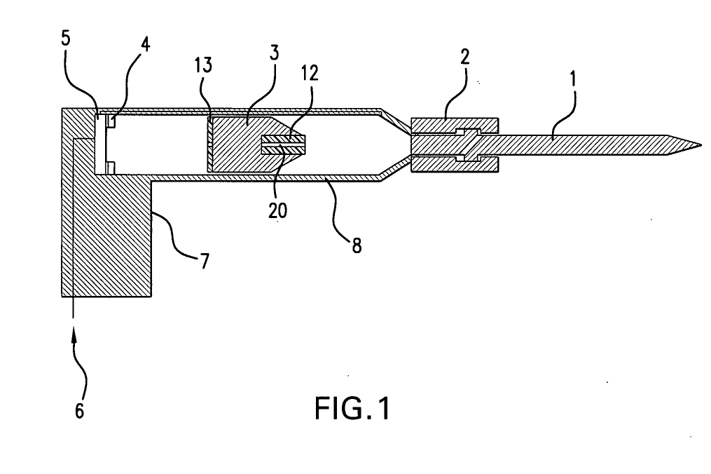

Referring to FIG. 1, a power impacter (1) typically includes an oscillating or reciprocating piston (3), a cutting tool which is often interchangeable which is impacted by the piston's front end (or ram's front end) which end of the piston is referred to as the impacting end. The piston's impacting end makes contact with what is referred to as the impacted end of the cutting tool. The cutting tool is interchangeable and is held in place by a tool retainer (2). The piston also contacts a piston stop (4) at the piston's back end. A valve (5) regulating air from a compressed air supply (6) is usually present, and is included simply for the sake of illustration. Also included in the tool is a source of receiving and delivering pneumatic or electrical power, and in some cases hydraulic power, to drive the piston, and a housing to support the components and provide a means of containing the impacting piston or ram, and a handle (7). The impacts of the piston in its piston bore (8) on both ends of its travel generate large forces that cause high vibration and noise.

The concept of this invention is to cushion the metal to metal impact by inserting or molding a relatively lower modulus inclusion between the metal components which is of lower modulus than the adjacent metal(s). The relatively lower modulus inclusion must be made of suitable materials of sufficiently high modulus and geometry to withstand repeated high impact forces without failing. In addition, the relatively lower modulus inclusion must not reduce the tool's cutting ability to unacceptable levels. The materials which can be selected for a high modulus polymeric material are referenced in PCT/US02/23448 entitled “An Anti-Spalling Combination on an Impact Tool With an Improved Holding System”. A preferred mode of this invention uses a polyamide, preferably nylon, and more particularly, reinforced nylon. More preferably, mineral reinforced nylon is preferred, in particular MINLON®, a trademarked product of DuPont Corp. of Wilmington, Del., USA and most especially, MINLON® 11C40 mineral reinforced nylon.

For purposes of this invention, the use of the word piston is intended to contemplate a ram, and also to include other driving mechanisms such as a cam (which normally acts against a ratchet), or a hammer internal to a tool which accomplishes the impacting effect of a piston.

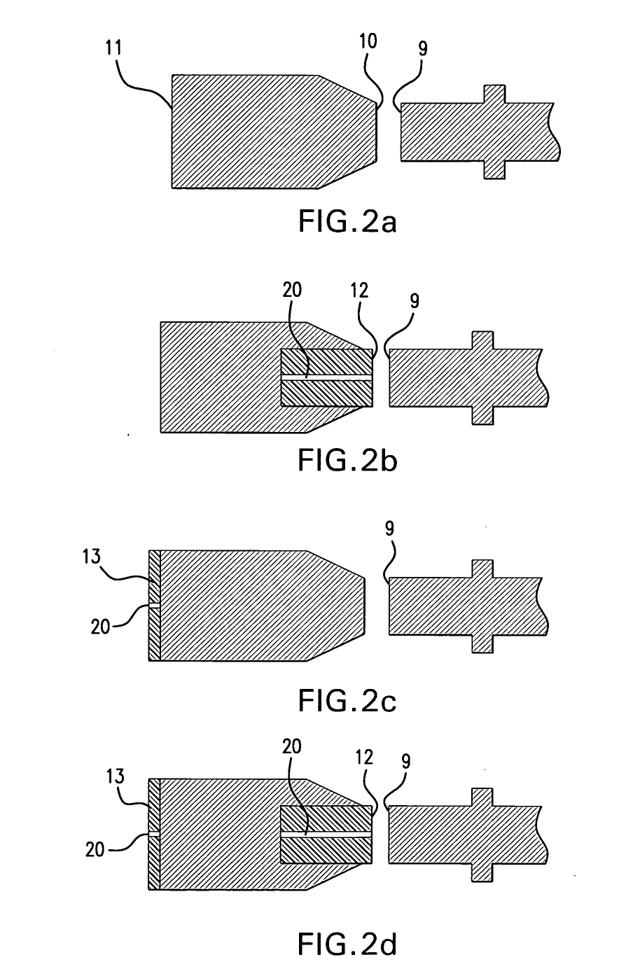

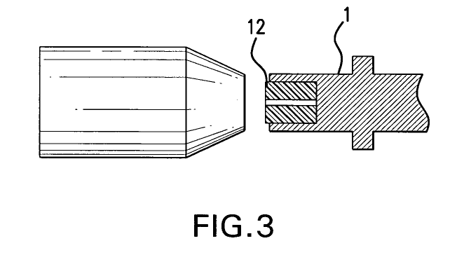

The repeated impacts on the forward end of the piston tend to easily damage even high modulus materials such as certain very high modulus polymers. Experiments have shown that a simple polymer disk inserted between the impacting end of the piston and impacted end of the cutting tool without modification of the cutting tool or impacting tool fails after a short operating time. However, it is possible to avoid failure by: inserting a relatively lower modulus inclusion, normally of a high modulus polymeric material, or lower modulus metal material than the adjacent metal material, in a cavity (14) in an impacting piston (FIG. 2b) and to further reduce such failure by also matching the contact geometry of the RLMI and the impacted end of the cutting tool (FIG. 3). The improvement occurs because the polymer stress concentrations are reduced greatly by the lateral support of the piston surrounding the cavity and the relatively lower modulus inclusion. If the contact geometry of the relatively lower modulus inclusion and the impacted end of the cutting tool are matched, there is further reduction of stress concentrations by the matched geometry.

The inventors have also observed that the preferred polymeric polymers appear to be ones that resist elevated temperature under impact. This in part appears to be because temperature can cause the polymeric material to break down. In other words, polymeric material is resistant to the heat generated by the dissipation of work resulting from the force from impact.

Depending on the material selected, the RLMI can be melted or molded into the adjacent material.

The following examples are given, without intending to restrict the scope of the invention, to illustrate the unexpected results from the novel design.

Examples of preferred embodiments

### First Example Set

Table 1 shows an embodiment demonstrating the result an RLMI made of a simple high modulus polymeric material and the shape of the polymeric material. The first test, Test 1, utilized the simple placement of a flat cylindrical disk between the impacted end of a chisel and the impact end of a reciprocating piston. Test 2 utilized the placement of an RLMI made of high modulus polymeric material contained in a corresponding cylindrical cavity interior to the face of the impacting end of an oscillating or reciprocating piston which cylindrical impact end was slightly larger than the diameter of a chamfered tool. The impact of the piston was therefore transmitted from the impacting end of the piston (10) through the RLMI to the striking end of the tool (9) and thence to the working end of a chisel. In Test 3, the cutting tool chamfer on the impacted end was removed so that the diameter of the impacting and impacted surfaces match. (See FIG. 3). In all of the tests with the RLMI, the RLMI protruded approximately 0.015 inches beyond the end of the impacting end of a reciprocating piston.

Test materials and test characteristics

Pneumatic chisel—Dayton Model 2Z486C Medium Air Hammer

Operating pressure—90 psi

Operating time—1 minute

Minion® reinforced polyamide used in all tests

An RLMI in the form of a high modulus polymeric inclusion placed on impacting end of piston (cutting tool side)

TABLE 1
Effect of Geometry of RLMI using
high modulus polymeric material

| Number | Shaped RLMI and impacting | |
|---|---|---|
| of | tool geometry corresponding to | |
| test | shaped RLMI | Damage to RLMI |
| Test 1 | Cylindrical disk | Broken in several pieces |
| Test 2 | Cylinder inserted in cavity in | Polymer survived repeated |
| | impacting end of piston | impacts, but significant shape |
| | Cylinder end - flat | distortion (which is indicative |
| | Cutting tool end - chamfered | of impending failure) at |
| | Cylinder diameter greater than | contact point with cutting tool |
| | small diameter of cutting tool | |
| | chamfer approximately equal | |
| | to diameter of cutting tool | |
| Test 3 | Cylinder inserted in cavity in | No damage |
| | impacting end of piston | |
| | Cylinder end - flat | |
| | Cutting tool end - flat | |
| | Cylinder diameter matches | |
| | diameter of impacted end of | |
| | cutting tool | |

The results, therefore, were that Test 1 shows that a simple disk shaped RLMI on the front side of the piston fails almost immediately because of the high impact forces. Test 2 shows that a major improvement occurs when the RLMI made of a high modulus polymeric material is cylindrical and placed in a corresponding cylindrical cavity interior to the face of the reciprocating piston. This improvement occurs because the wall of the cavity prevents the RLMI from expanding. The stresses are distributed more uniformly in all radial directions, similar to forces exerted by a liquid in a container, without substantial deformation of the cylindrical RLMI and failure is avoided. Such radially uniform stress decreases the rate of failure. Test 3 shows that an additional improvement can be achieved by also matching the geometry of the RLMI and the impacted end of the cutting tool contact surface.

### Second Example Set

Table 2 shows the result of an embodiment of an RLMI made of a simple high modulus metal material of lower modulus than the adjacent metal without any modification of geometry, in this instance, using aluminum where the main tool material is steel. Two sets of tests were run with a conventional reciprocating piston and another with a hand-held tool.

Two tests were run on a test stand. The first configuration utilized the simple placement of a flat cylindrical disk between the impacted end of a chisel and the impact end of a conventional reciprocating piston. The second configuration utilized placement of an RLMI of lower modulus than the adjacent steel surfaces, namely aluminum, contained in a corresponding cylindrical cavity interior to the face of the impacting end of a reciprocating piston which cylinder was the diameter of a chamfered tool.

Two tests were run with a hand-held tool. As with the test stand, the first configuration utilized the simple placement of a flat cylindrical disk between the impacted end of a chisel and the impact end of a conventional reciprocating piston. The second configuration utilized placement of an RLMI of lower modulus than the adjacent steel surfaces, namely aluminum, contained in a corresponding cylindrical cavity interior to the face of the impacting end of a reciprocating piston which cylinder was the diameter of a chamfered tool. The impact of the piston was therefore transmitted through the RLMI to the working end of a chisel.

Test materials and test characteristics

Pneumatic chisel—Dayton Model 2Z486C Medium Air Hammer

Operating pressure—90 psi

Operating time—1 minute

Aluminum used in all tests

RLMI of polymeric material placed on piston stop end

TABLE 2
Effect of RLMI on Power Tool Vibrations.

| Tool support | Configuration | Axial vibrations (g's) |
|---|---|---|
| Test stand | Conventional piston | 400 |
| Test stand | RLMI inserted in cavity in | 365 |
| | impacting end of piston | |
| Hand held | Conventional piston | 540 |
| Hand held | RLMI inserted in cavity in | 325 |
| | impacting end of piston | |

The addition of the RLMI reduced the power tool vibration by cushioning the metal-metal impact of the piston on the cutting tool. Continued measurement has shown that the more irritating high frequency vibrations and associated sound are substantially reduced and redistributed. Both a qualitative and quantitative reduction are perceived. It is the higher frequencies which are the most medically troublesome.

### Third Example Set

Table 3 shows the result of an embodiment of a simple RLMI on the noise from a power tool. In this example, there were four configurations. Table 3 shows the results of an experiment in which an RLMI was added to a conventional power chisel on: the front, the back, and both sides of the piston.

More specifically, the first configuration was a control with no RLMI and the metal impacting end of an unmodified piston (16) hitting the impacted end of a cutting chisel. The second configuration was placement of a cylindrical insert of an RLMI in a cavity on the impacting end of the piston. The third configuration was placement of an RLMI cylindrical disk (15) on the back of the piston (11). The final and fourth configuration was placement of an RLMI cylindrical insert in a cavity on the impacting end of the piston and placement of an RLMI cylindrical disk on the back of the piston.

Test materials and test characteristics

Pneumatic chisel—Dayton Model 2Z486C Medium Air Hammer

Operating pressure—90 psi

Operating time—sufficient to gather data

Minion® reinforced polyamide used in all tests

The mean sound pressure was measured in dBA. A LinearX 150 mm diameter precision acoustic measurement microphone (Model M51A) with an acoustic sensitivity of 11.086 mV/94.00 dBspl was used for all tests. A DC supply of 9 volts powered the calibrated microphone and a National Instruments Data Acquisition Card (E-Series, PCMCIA 16-bit) and laptop computer were used to record the sound signal. All experiments were conducted at a sampling rate of 120,000 Hz. A LabVIEW program was written to gather the data as well as process and analyze the obtained signals for meaningful information.

TABLE 3
Effect of RLMI on Power Tool Noise

| | Sound Level |
|---|---|
| | (Mean Sound Pressure |
| RLMI material configuration | Level dBA |
| No modification | 104.3 |
| Cylinder inserted in cavity in impacting end of | 101.6 |
| piston | |
| Cylindrical disk placed on back of piston | 103.3 |
| Cylinder inserted in cavity in impacting end of | 101.3 |
| piston and Cylindrical disk placed | |
| on back of piston | |

The results show that adding an RLMI significantly reduces power tool noise by cushioning the metal-metal impact of the piston.

### Fourth Example Set

Table 4 shows the result of an embodiment of a simple RLMI made of high modulus polymeric material on the time to cut a 0.125 inch steel rod. The first test is with a conventional tool, and the second test is with placement of a cylindrical insert of an RLMI made of a high modulus polymeric inclusion in a cavity on the impacting end of the piston and placement of a cylindrical disk of an RLMI made of a high modulus polymeric material on the back of the piston.

Test materials and test characteristics

Pneumatic chisel—Dayton Model 2Z486C Medium Air Hammer

Operating pressure—90 psi

Minion® reinforced polyamide used in all tests

TABLE 4
Cutting Performance of Power Tool with RLMI Inserted

| | Time to Cut 0.125 |
|---|---|
| Configuration | inch steel rod |
| Conventional Tool without modification | 10 seconds +/− 5 seconds |
| Cylinder inserted in cavity in impacting end of | 13 seconds +/− 6 seconds |
| piston and Cylindrical disk placed on | |
| back of piston | |

Results show that the time to cut a 0.125 inch diameter bolt with the RLMI tool did not significantly increase when compared to the conventional pneumatic chisel. This is an important result because “cushioning” the impact could seriously affect performance if not done properly.

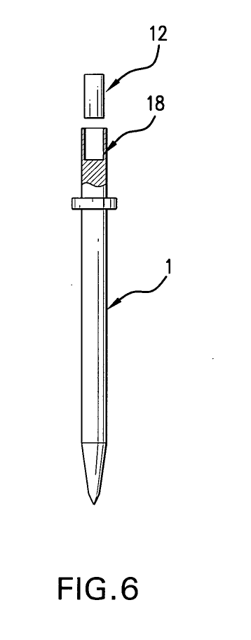

The inventors have discovered that by applying a cyclic compression force to the RLMI, a surprising result has emerged of significantly improved reduction of time to failure for an RLMI in an impact tool. This compression and seating of an RLMI is performed by utilizing an Instron (Boston, Mass.) hydraulic machine and applying a 40 Hz non-impacting pressure to the RLMI to seat it in a cavity in the interchangeable working tool. The Relatively Low Modulus Insert (“RLMI”) (12) would be pressed snuggly into the just described recess of the cutting tool (18). FIG. 6 shows the relative disposition of the RLMI (12), the recess, the impacted end and the cutting or working end of the impacted tool. The RLMI is loaded in by hydraulic compression for a number of cycles in order to fully insure that the RLMI is fully compressed in the recess. This is referred to as cyclic compression load.

In sum, the most preferred mode is a relatively lower modulus inclusion (RLMI) in the form of an insert made of fiber or mineral reinforced polymeric material, preferably a polyamide, and preferably nylon.

The material for the RLMI, which can be a metal, such as aluminum, in a cavity in a steel tool or steel piston or ram, is of a lower modulus than the surrounding steel or similar tool material; again it is a relatively lower modulus insert, not a material of low modulus.

The inventors used a cylindrically shaped MINLON® 11C40 mineral reinforced nylon having a small aperture to enable the RLMI to be seated in a cavity in an interchangeable working tool. In order to seat the RLMI in the cavity, a 40 Hz non-impacting pressure is applied to the RLMI. Air escapes through the aperture (20) which runs the length of the RLMI perpendicular to the radius of the cylindrically shaped RLMI. The RLMI is designed such that the RLMI will protrude at least 0.005 inches above the plane of the striking end hit by a reciprocating piston when the interchangeable working tool is loaded into a power impacter. The recess or cavity diameter must be scaled to maintain adequate wall thickness in the cutting tool. The initial design proposed a depth of recess is approximately three times its diameter. MINLON® 8018 is another alternative.

The recess may have rounded corners on the interior of the recess to better distribute stresses.

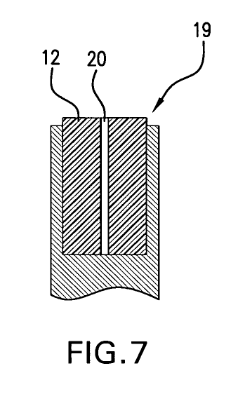

The initial RLMI length must be set to a level that causes the RLMI to protrude above the cutting tool surface. The relative position of protrusion of the RLMI (12) shown in FIG. 7 and marked as 19. The preferable length L of protrusion is at least 0.010 in. (0.254 mm.). The RLMI could have a pre-determined length which compresses slightly leaving the desired protrusion L, or the RLMI after compression could be cut or sheared to the desired protrusion L. The desired protrusion length (L) is at least 0.005 inches (0.127 mm.) after pre-treatment by compression into the cavity. The diameter of the RLMI should be slightly larger than the cavity so that the RLMI is compressed as it is inserted and seated.

The protrusion prevents the impacting metal surfaces from contacting each other. When an RLMI of diameter 0.5 inches and length of 0.9 inches was compressed into the impacted end of a chisel, and a 0.013 inch (0.330 mm.) protrusion was present, the cutting tool maintained the protrusion for an extended period involving more than 150,000 impacts. The surprising result is that as a result of the pre-compression, the number of impacts sustained by the RLMI was substantially improved by a factor of over 20, thus substantially improving the survivability of the RLMI and avoiding the undesirable vibration and noise of metal to metal contact.

As previously described in PCT/US02/23448 entitled “An Anti-Spalling Combination on an Impact Tool With an Improved Holding System,” the cutting tool could have a sharper included angle because the tool edge receives slightly less force transmitted to it as a result of the RLMI and can therefore have a more acute angle. This assists in maintaining impact effectiveness. Impact effectiveness is meant to mean the ratio of the number of blows for the impacting tool without the cutting tool modified by a more acute angle and without the RLMI. divided by the number of blows for the impacting tool with the RLMI and the cutting tool with the sharper included angle. Thus, a 50% impact effectiveness would mean an oscillating, including reciprocating, impacting tool with an ordinary chisel tool which took 10 blows to cut an ordinary drill rod would not take more than 20 blows with the RLMI and more acute chisel.

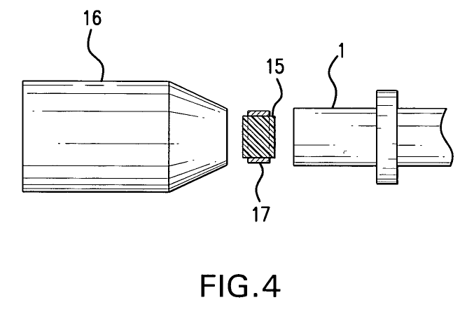

An alternate mode of invention is a disk encased in a supporting metal ring with protrusions of the disk of a shaped polymeric material to prevent metal to metal contact, which disc is interposed between a ram/piston and a tool. This is shown in FIG. 4.

To quiet the impacting tool system further, an RLMI in the form of a disc at the stop end of a piston or ram is also contemplated. This is not subject to the kinds of forces as the impacting end of the piston or the impacted end of the tool. Also contemplated is that the RLMI for the impacted end need not be made of the same material as the RLMI for the stop end of the piston or ram, and one or both ends of the piston or ram can have the RLMI. An alternative preferred mode is to have the impacting end have an RLMI made of aluminum (which has a lower modulus than steel) with the stop end of the piston end having an RLMI of high modulus polymeric material like Minion®. The impacted end of the working portion of the tool such as a chisel could have an RLMI as well.

It is preferable that the diameter of the piston/ram be slightly larger than the RLMI in a chisel or impacted tool. Further the impacted tool should have an impacting end congruent to the shape of the RLMI, which as stated, should be flat with a modest protrusion. The impacting end should then be preferably flattened to correspond to the flattened RLMI. Alternatively, as another mode, the RLMI could be even with the impacting end of the reciprocating tool, or even recessed.

While an RLMI flat disk at the opposite end of the impacting end of the tool (the stop end of the piston end) is preferable and adequate, an RLMI could be located at the stop end in a cavity which RLMI has a modest protrusion, is flat to the stop end, or is recessed slightly.

The invention can be applied to an air hammer, including a small version often popularly known as a “palm nailer.” In this application, the piston or ram of the air hammer has the RLMI in a cavity on the piston. The RLMI protrudes slightly, and as the piston reciprocates, hits the object being driven such as a nail. The invention is thus also applicable to be scaled up all the way to the ram for a jackhammer or even a pile driver.

For certain impacting tools using a cam to drive a ratchet, the RLMI could be in the surface of the cam where impact occurs, or in the impacted surface of the ratchet. Where a tool has a hammer or striker internal to a tool which accomplishes the impacting effect of a piston, the RLMI could be in the hammer face or striker face, or in the impacted surface that is impacted by the hammer.

The Minion® 11C40 can also be stacked into the cavity and the desired thickness of sandwiched pieces obtained. An adhesive could be used between the stacked pieces.

With respect to using a metal RLMI, such as aluminum, in a steel piston or shaft of a working tool, the inventors proposed that the modulus of the metal RLMI be at least 5 times lower than the modulus of any adjacent impacting or impacted metal.

A retaining ring to eliminate the softer vibration and sound from the tool retainer against the tool is also proposed. This would be preferably be made of a polymeric material.

The invention is not meant to be limited to the disclosures, including best mode of invention herein, and contemplates all equivalents to the invention and similar embodiments to the invention.

1. An impacting tool comprising:
a piston for impacting a tool;
a shaft of a tool having a working end and a striking end;
a shaped relatively lower modulus inclusion (RLMI) inserted in a cavity in said striking end;
said RLMI protruding from said cavity in said striking end exterior to the plane of the opening of said cavity In said striking end, said RLMI being positioned to reduce direct metal-to-metal impact between said striking end and said piston of said impacting tool.

2. The impacting tool according to claim 1, further comprising:
said RLMI being made of polymeric material.

3. The impacting tool according to claim 2, further comprising:
said RLMI being made of reinforced polymeric material.

4. The impacting tool according to claim 3, further comprising:
said reinforced polymeric material of said RLMI being reinforced by material selected from the group of fiber or particulate.

5. The impacting tool according to claim 4, further comprising:
said RLMI being made of reinforced nylon.

6. The impacting tool according to claim 5, further comprising:
said reinforced nylon being reinforced by mineral particulate.

7. The impacting tool according to claim 6, further comprising:
said RLMI being made of DuPont Corp. MINLON® 11C40.

8. The impacting tool according to claim 1, further comprising:
said striking end being made of metallic material;
said RLMI being made of metal of lower modulus than said metallic material.

9. The impacting tool according to claim 8, further comprising;
said RLMI of lower modulus protruding from said cavity in said striking end exterior to the plane of the opening of said cavity in said striking end to avoid direct metal-to-metal impact between said piston and said striking end.

10. The impacting tool according to claim 2, further comprising:
said RLMI being seated in said cavity by cyclic compression loads against said RLMI while maintaining said characteristic of said RLMI protruding from said cavity after said cyclic compression loads in order for said RLMI protruding from said cavity to reduce direct metal-to-metal impact between said piston and said striking end.

11. The impacting tool according to claim 10, further comprising:
said RLMI having an aperture to enable said RLMI to be more deeply seated in said cavity.

12. The impacting tool according to claim 11, further comprising:
said reinforced polymeric material of said RLMI being reinforced by material selected from the group of fiber or particulate.

13. The impacting tool according to claim 12, further comprising:
said RLMI being made of reinforced nylon.

14. The impacting tool according to claim 13, further comprising:
said reinforced nylon being reinforced by mineral particulate.

15. The impacting tool according to claim 14, further comprising:
said RLMI being made of DuPont Corp. MINLON® 11C40.

16. An impacting tool comprising:
a piston for impacting a tool;
a shaft of a tool having a working end and a striking end;
a shaped relatively lower modulus inclusion (RLMI) made of reinforced polymeric material inserted in a cavity on said piston, said reinforced polymeric material being reinforced by material selected from the group of fiber or particulate;
said RLMI protruding from said cavity in said striking end exterior to the plane of the opening of said cavity in said piston positioned to reduce direct metal-to-metal impact between said shaft and said piston of said impact tool.

17. The impacting tool according to claim 16, further comprising:
said impacting tool having an oscillating piston repeatedly striking said working tool through said RLMI in said striking end.

18. The impacting tool according to claim 17, further comprising:
said RLMI being made of reinforced nylon.

19. The impacting tool according to claim 18, further comprising:
said reinforced nylon being reinforced by mineral particulate.

20. The impacting tool according to claim 19, further comprising:
said RLMI being made of DuPont Corp. MINLON® 11C40.

21. The impacting tool according to claim 20, further comprising:
said RLMI having an aperture to enable said RLMI to be more deeply seated in said cavity.

22. The impacting tool according to claim 16, further comprising:
said RLMI being pretreated by cyclic compressive load to be pressed into said cavity while maintaining said characteristic of said RLMI protruding from said cavity after said being pretreated by cyclic compressive load, or order for said protruding to reduce direct metal-to-metal impact between said shaft and said piston of said impacting tool.

23. The impacting tool according to claim 22, further comprising:
said RLMI being made of reinforced nylon.

24. The impacting tool according to claim 23, further comprising:
said reinforced nylon being reinforced by mineral particulate.

25. The impacting tool according to claim 24, further comprising:
said RLMI being made of DuPont Corp. MINLON® 11C40.

26. The impacting tool according to claim 25, further comprising:
said RLMI having an aperture to enable said RLMI to be more deeply seated in said cavity.

27. The impacting tool according to claim 26, further comprising:
said reinforced RLMI continuing to protrude at least 0.005 inches (0.122 mm.) from said cavity and thereby reducing direct metal-to-metal impact between said piston and said working tool for greater than 10,000 impact cycles.

28. An impacting tool comprising:
a piston for impacting a tool;
a tool having a working end and a striking end;
a shaped relatively lower modulus inclusion (RLMI) inserted in a cavity in said striking end;
said RLMI protruding from said cavity in said striking end exterior to the plane of the opening of said cavity in said striking end, said RLMI being positioned to reduce direct metal-to-metal impact between said striking end and said piston of said impacting tool.

29. The impacting tool according to claim 28, further comprising:
said RLMI being made of polymeric material.

30. The impacting tool according to claim 29, further comprising:
said RLMI being made of reinforced polymeric material.

31. The impacting tool according to claim 30, further comprising:
said reinforced polymeric material of said RLMI being reinforced by material selected from the group of fiber or particulate.

32. The impacting tool according to claim 31, further comprising:
said RLMI being made of reinforced nylon.

33. The impacting tool according to claim 32, further comprising:
said reinforced nylon being reinforced by mineral particulate.

34. The impacting tool according to claim 33, further comprising:
said RLMI being made of DuPont Corp. MINLON® 11C40.

35. The impacting tool according to claim 28, further comprising:
said piston being made of metallic material;
said RLMI being made of metal of lower modulus than said metallic material.

36. The impacting tool according to claim 35, further comprising;
said RLMI of lower modulus protruding from said cavity in said piston exterior to the plane of the opening of said cavity in said striking end to avoid direct metal-to-metal impact between said piston and said striking end.

37. The impacting tool according to claim 29, further comprising:
said RLMI being seated in said cavity by cyclic compression loads against said RLMI while maintaining said characteristic of said RLMI protruding from said cavity after said cyclic compression loads in order for said RLMI protruding from said cavity to reduce direct metal-to-metal impact between said piston and said striking end.

38. The impacting tool according to claim 37, further comprising:
said RLMI having an aperture to enable said RLMI to be more deeply seated in said cavity.

39. The impacting tool according to claim 38, further comprising:
said reinforced polymeric material of said RLMI being reinforced by material selected from the group of fiber or particulate.

40. The impacting tool according to claim 39, further comprising:
said RLMI being made of reinforced nylon.

41. The impacting tool according to claim 40, further comprising:
said reinforced nylon being reinforced by mineral particulate.

42. The impacting tool according to claim 41, further comprising:
said RLMI being made of DuPont Corp. MINLON® 11C40.

43. An impacting tool comprising:
a piston for impacting a tool;
a shaft of a tool having a working end and a striking end;
a shaped relatively lower modulus inclusion (RLMI) made of reinforced polymeric material inserted in a cavity on said piston, said reinforced polymeric material being reinforced by material selected from the group of fiber or particulate;
said RLMI protruding from said cavity in said piston exterior to the plane of the opening of said cavity in said piston, said RLMI being positioned to reduce direct metal-to-metal impact between said shaft and said piston of said impact tool.

44. The impacting tool according to claim 43, further comprising:
said piston having an impacting end having said cavity;
said piston acting through said RLMI against said working end of said working tool;
said impacting tool having an oscillating impacting end on said piston repeatedly striking said working tool through said RLMI in said impacting end.

45. The impacting tool according to claim 44, further comprising:
said RLMI being made of reinforced nylon.

46. The impacting tool according to claim 45, further comprising:
said reinforced nylon being reinforced by mineral particulate.

47. The impacting tool according to claim 46, further comprising:
said RLMI being made of DuPont Corp. MINLON® 11C40.

48. The impacting tool according to claim 45, further comprising:
said RLMI having an aperture to enable said RLMI to be more deeply seated in said cavity.

49. The impacting tool according to claim 43, further comprising:
said RLMI being pretreated by cyclic compressive load to be pressed into said cavity while maintaining said characteristic of said RLMI protruding from said cavity after said being pretreated by cyclic compressive load, or order for said protruding to reduce direct metal-to-metal impact between said shaft and said piston of said impacting tool.

50. The impacting tool according to claim 49, further comprising:
said RLMI being made of reinforced nylon.

51. The impacting tool according to claim 50, further comprising:
said reinforced nylon being reinforced by mineral particulate.

52. The impacting tool according to claim 51, further comprising:
said RLMI being made of DuPont Corp. MINLON® 11C40.

53. The impacting tool according to claim 52, further comprising:
said RLMI having an aperture to enable said RLMI to be more deeply seated in said cavity.

54. The impacting tool according to claim 53, further comprising:
said reinforced RLMI continuing to protrude from said cavity at least 0.005 inches (0.122 mm) sufficient to reduce and thereby reducing direct metal-to-metal impact between said piston and said working tool for greater than 10,000 impact cycles.

55. An impacting tool comprising:
an oscillating piston made of a metal for driving an object;
a shaft of a tool having a working end and a striking end;
a shaped metal material of lower modulus than said metal to be inserted in a cavity on said striking end;
said shaped material of lower modulus protruding from said cavity in said striking end exterior to the plane of said opening of said cavity in said striking end, said RLMI being positioned to reduce direct metal-to-metal impact between said shaft and an impact tool.

56. The impacting tool according to claims 1-55, further comprising:
said tool having an insertable striking end of said tool contained upon insertion in said impacting tool adjacent to an impacting end of said piston; and
said impacting tool having a ring made of at least one reinforced polymeric material for securing said tool.

57. An impacting tool comprising:
an oscillating piston for repeatedly impacting an object to be driven;
a piston of said impacting tool having an impacting end and a stopping end;
a shaped relatively lower modulus inclusion (RLMI) made of reinforced polymeric material, said reinforced polymeric material of said RLMI being reinforced by material selected from the group of fiber or particulate, said RLMI being placed into a cavity in said piston located in at least at said impacting end and protruding from said cavity;
said RLMI being seated in said cavity by cyclic compression loads against said RLMI while maintaining said characteristic of said RLMI protruding from said cavity after said cyclic compression loads in order for said RLMI protruding from said cavity to reduce direct metal-to-metal impact between said piston and said object to be driven.

58. The impacting tool according to claim 57, further comprising:
said reinforced nylon being reinforced by mineral particulate.

59. The impacting tool according to claim 58, further comprising:
said RLMI being made of DuPont Corp. MINLON® 11C40.

60. The impacting tool according to claim 59, further comprising:
said RLMI having an aperture to enable said RLMI to be more deeply seated in said cavity.

61. The impacting tool according to claim 60, further comprising:
said RLMI continuing to protrude from said cavity at least 0.005 inches (0.122 mm) for greater than 10,000 impact cycles.

62. The impacting tool according to claim 57, further comprising:
said object to be repeatedly driven being a removable working tool.

63. The impacting tool according to claim 62, further comprising:
said RLMI being made of reinforced nylon.

64. The impacting tool according to claim 63, further comprising:
said reinforced nylon being reinforced by mineral particulate.

65. The impacting tool according to claim 64, further comprising:
said RLMI being made of DuPont Corp. MINLON® 11C40.

66. The impacting tool according to claim 65, further comprising:
said RLMI having an aperture to enable said RLMI to be more deeply seated in said cavity.

67. The impacting tool according to claim 66, further comprising:
aid RLMI being made of nylon reinforced by mineral particulate;
said RLMI continuing to protrude from said cavity at least 0.005 inches (0.122 mm) for greater than 10,000 impact cycles.

68. The impacting tool according to claims 1-67, further comprising:
said impacting tool being a tool for performing cutting;
said impacting tool having an RLMI;
said impacting tool having an interchangeable working tool end;
said working tool end having a cutting edge;
said working tool end having a standard included angle for said cutting edge;
said working tool end being modified to reduce said included angle for said cutting edge thereby making said angle more acute so that in combination with said RLMI, said impacting tool cuts with not less than 50% impact effectiveness.

69. An impacted tool to be impacted by an oscillating piston of an impacting tool, comprising:
a shaft having a working end and a striking end;
a shaped relatively lower modulus inclusion (RLMI) inserted in a cavity in said striking end;
said RLMI protruding from said cavity in said striking end exterior to the plane of the opening of said cavity in said striking end, said RLMI being positioned to reduce direct metal-to-metal impact between said striking end and said piston of said impacting tool.

70. The impacted tool according to claim 69, further comprising:
said RLMI being made of polymeric material.

71. The impacted tool according to claim 70, further comprising:
said RLMI being made of reinforced polymeric material.

72. The impacted tool according to claim 71, further comprising:
said reinforced polymeric material of said RLMI being reinforced by material selected from the group of fiber or particulate.

73. The impacted tool according to claim 72, further comprising:
said RLMI being made of reinforced nylon.

74. The impacted tool according to claim 73, further comprising:
said reinforced nylon being reinforced by mineral particulate.

75. The impacted tool according to claim 74, further comprising:
said RLMI being made of DuPont Corp. MINLON® 11C40.

76. The impacted tool according to claim 69, further comprising:
said striking end being made of metallic material;
said RLMI being made of metal of lower modulus than said metallic material.

77. The impacted tool according to claim 76, further comprising;
said RLMI of lower modulus protruding from said cavity in said striking end exterior to the plane of the opening of said cavity in said striking end, said RLMI being positioned to avoid direct metal-to-metal impact between said piston and said striking end.

78. The impacted tool according to claim 77, further comprising:
said RLMI being seated in said cavity by cyclic compression loads against said RLMI while maintaining said characteristic of said RLMI protruding from said cavity after said cyclic compression loads in order for said RLMI protruding from said cavity to reduce direct metal-to-metal impact between said piston and said striking end.

79. The impacted tool according to claim 78, further comprising:
said RLMI having an aperture to enable said RLMI to be more deeply seated in said cavity.

80. The impacting tool according to claims 8, 9, 35, 36, 76, 77, 78, and 79, further comprising:
said piston being made of metallic material;
a disk on said piston opposite said cavity, said disk being made of material of lower modulus than said metallic material.

81. The impacting tool according to claims 1-79, further comprising:
said piston being made of a material of a given modulus,
said RLMI being made of a material having a modulus at least 5 times lower than said given modulus of said material of said piston.
